(19) United States
(12) Patent Application Publication
(10) Pub. No.: US 2023/0370872 A1
(43) Pub. Date: Nov. 16, 2023

(54) GNB-CU-UP Data Plane High Availability In Public/Private Cloud

(71) Applicant: Parallel Wireless, Inc., Nashua, NH (US)

(72) Inventors: Mukesh Singhal, Pune (IN); Nikhil Agarwal, Pune (IN)

(21) Appl. No.: 18/317,920

(22) Filed: May 15, 2023

Related U.S. Application Data
(60) Provisional application No. 63/341,553, filed on May 13, 2022.

(51) Int. Cl. H04W 24/04

(52) U.S. Cl. CPC H04W 24/04

(57) ABSTRACT

The presently described invention provides gNB-CU-UP data plane high availability in a public or private cloud. In one embodiment, a method of providing gNB-CU-UP data plane high availability in public/private cloud includes identifying, by an internal controller, when a data-plane Pod crashes; initiating, by the internal controller, procedures to make a passive POD to an active state; the procedures including at least one of: maintaining, by the passive POD, all flows of all active PODs in it as backup; identifying, by the passive POD, flows of the impacted data-plane POD and marking those flows to an active state; marking remaining non-active flows at the passive POD to be removed; triggering, by the internal controller, label changing of the passive data-plane POD; migrating data-plane Internet Protocol (IP) of crashed POD to the passive data-plane POD; and launching, by a Service Management and Orchestration (SMO), a new passive POD for backup.

### CROSS-REFERENCE TO RELATED APPLICATIONS

This application claims priority under 35 U.S.C. § 119(e) to U.S. Provisional Pat. Application No. 63/341,553, filed May 13, 2022 and having the same title as the present application, and which is hereby incorporated by reference in its entirety for all purposes. In addition, the present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. Pat App. No. 14/777,246, “Methods of Enabling Base Station Functionality in a User Equipment,” filed Sep. 15, 2016; U.S. Pat. App. No. 14/289,821, “Method of Connecting Security Gateway to Mesh Network,” filed May 29, 2014; U.S. Pat. App. No. 14/642,544, “Federated X2 Gateway,” filed Mar. 9, 2015; U.S. Pat. App. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. Pat. App. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815US01); US20170273134A1 (PWS-71850US01); US20170272330A1 (PWS-71850US02); and 15/713,584 (PWS-71850US03). This application also hereby incorporates by reference in their entirety U.S. Pat. Application No. 16/424,479, “5G Interoperability Architecture,” filed May 28, 2019; and U.S. Provisional Pat. Application No. 62/804,209, “5G Native Architecture,” filed Feb. 11, 2019; and U.S. Pat. App. No. 18/174,580, titled “O-RAN Compatible Deployment Architecture,” filed Feb. 24, 2023. This application also incorporates by reference the U.S. patent application having docket number PWS-72749US01, filed 2022-08-16 with application no. 17/819950 and title “4G/5G Open RAN CU-UP High Availability Solution”; the U.S. Pat. Application having docket number PWS-72754US01, filed 2022-12-19 with application no. 18/068520 and title “CU-CP High Availability”; and the U.S. Pat. Application having docket number PWS-72765US01, filed 2022-12-29 with application no. 18/148432 and title “Singleton Microservice High Availability.”

### BACKGROUND

gNodeB-Centralized Unit-User Plane (gNB-CU-UP) handles Radio Resource Control (RRC) and the control plane part of the Packet Data Convergence Protocol (PDCP) protocol. This node communicates with a Distributed Unit (DU) over F1-C interface and with CU-UP over E1 interface as defined in 3GPP specifications. The gNB-CU-UP is a critical node for providing good user experience to end subscriber.

A Pod is a group of one or more containers, with shared storage and network resources, and a specification for how to run the containers. A Pod’s contents are always co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. If any of the data-plane PODs crashes which will result into loss of subscriber data-session and end to end connectivity.

In some embodiments, one or more network functions as described herein may be provided by virtualized servers, which may be provided using containerization technology. Containers decouple applications from underlying host infrastructure. This makes deployment easier in different cloud or OS environments. A container image is a ready-to-run software package, containing everything needed to run an application: the code and any runtime it requires, application and system libraries, and default values for any essential settings. Containers may include the use of Kubernetes or other container runtimes.

In Kubernetes, A pod (as in a pod of whales or pea pod) is a group of one or more containers, with shared storage and network resources, and a specification for how to run the containers. A Pod’s contents are always co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. Pods are configured in Kubernetes using YAML files.

For example, a controller for a given resource provided using containers handles replication and rollout and automatic healing in case of Pod failure. For example, if a Node fails, a controller notices that Pods on that Node have stopped working and creates a replacement Pod. The scheduler places the replacement Pod onto a healthy Node.

The use of containerized technologies is rapidly spreading for providing 5G core (5GC) technologies. The present disclosure is deployed using containerized technologies, in some embodiments.

Further details regarding some embodiments may be found in U.S. Pat. App. Publication Nos. US20200045565A1 and US20200042365A1, each of which are hereby incorporated by reference in their entirety for all purposes.

### SUMMARY

The presently described invention provides gNB-CU-UP data plane high availability in a public or private cloud. In one embodiment, a method of providing gNB-CU-UP data plane high availability in public/private cloud includes identifying, by an internal controller, when a data-plane Pod crashes; initiating, by the internal controller, procedures to make a passive POD to an active state; the procedures including at least one of: maintaining, by the passive POD, all flows of all active PODs in it as backup; identifying, by the passive POD, flows of the impacted data-plane POD and marking those flows to an active state; marking remaining non-active flows at the passive POD to be removed; triggering, by the internal controller, label changing of the passive data-plane POD; migrating data-plane Internet Protocol (IP) of crashed POD to the passive data-plane POD; and launching a new passive POD for backup. Launching may be by an SMO, or by an internal controller at the CU-UP.

### BRIEF DESCRIPTION OF THE DRAWINGS

FIG. 1 shows a schematic CU-CP/CU/CP open RAN architecture, in accordance with some embodiments.

FIG. 2 depicts a schematic logical architecture of a gNB-CU-UP, in accordance with some embodiments.

FIG. 3 depicts a schematic logical architecture of a gNB-CU-UP data plane with high availability, in accordance with some embodiments.

FIG. 4 depicts a schematic logical architecture of a gNB-CU-UP data plane with high availability in operation, in accordance with some embodiments.

FIG. 5 shows a schematic architecture for a internal service discovery framework, in accordance with some embodiments.

FIG. 6 is a schematic diagram of a multi-RAT RAN deployment architecture, in accordance with some embodiments.

### DETAILED DESCRIPTION

Public/private cloud infrastructure provides resource high-availability or scaling solution. But it does not fully solve high-availability with no down time for nodes like gNB-CU-UP.

A gNB-CU-UP node is deployed with single data-plane POD. Due to some reason that data-plane crashes. These single data-plane PODs can be as big as single host/node with multiple cores. Loss can be significant in one area served by single gNB-CU-UP.

As part of SON (self-organizing network) features, MLB (Mobility Load Balancing), introduced in (3GPP TS 32.860, hereby incorporated by reference), provides capabilities to optimize network capacity. Traditional approach mainly aims to optimize the resource utilization with control on cell level parameters. In some embodiments, this disclosure enhances the Traffic Steering use case as part of ORAN use cases by employing UE level information to make more accurate decisions. The goal of both is to reach maximal resource utilization across multiple cells/Nodes with minimal to no compromise on end user experience.

Considering high level architecture, the feature includes three main steps. First, data level, what information is collected (e.g. load metric, UE measurements, ...), from whom its collected (granularity level UE/cell/Node), and how frequently is it collected. Second, algorithm level. the core of the logic itself, it needs to be robust to handle various use cases and various scenarios. Third, provisioning (decision implementation), what accuracy level is aimed while making the changes at UE, Cell, Node etc.

Certain terms and acronyms used in this description are described below.

CU-CP: This node handles RRC and the control plane part of the PDCP protocol. This node communicates with DU over F1-C interface and with CU-UP over E1 interface as defined in 3GPP specifications.

CU-UP/s: This node handles user plane part of PDCP protocol and SDAP protocol. It communicates with CU-CP over E1 interface and with DU over F1-U interface.

SMO (Service management and orchestration). SMO is responsible for orchestration and management of gNB-CU-UP, gNB-CU-CP & DU node. Control of infra structure component like CPU/Memory and scale up and scale down operations. FCAPS (Fault, Configuration, Security, Performance, Accounting) management of Open-RAN elements (gNB-CU-CP, gNB-CU-UP, gNB-DU)

AMF/SMF: 3GPP defined 5G core network element for control signaling.

UPF: 3GPP defined 5G core network element for data-plane traffic.

DU (gNB-DU): 3GPP defined 5G access network element.

E1-Micro-service: Internal Micro-service in CU-UP cluster to handle SCTP + E1-APP interface signaling with gNB-CU-CP. E1-APP & SCTP connections terminates at E1-micro-service.

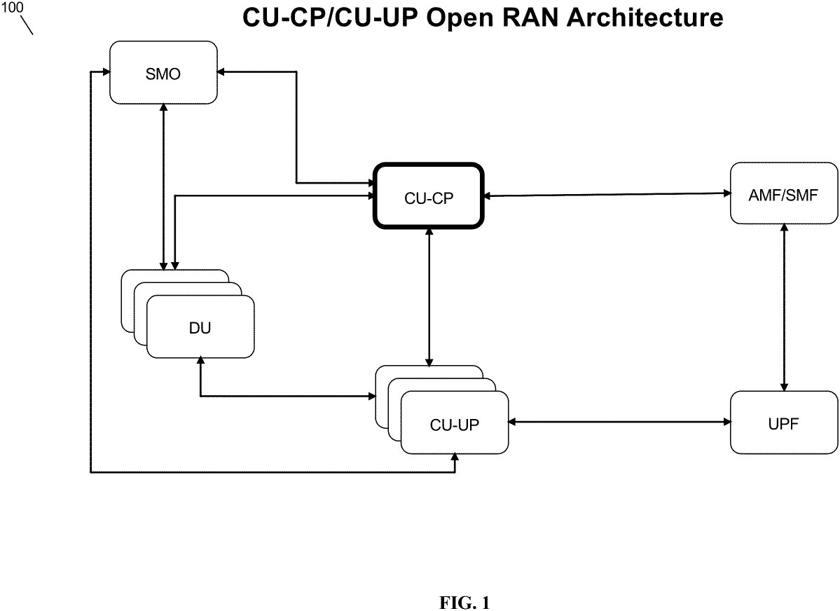

FIG. 1 shows a schematic CU-CP/CU/CP open RAN architecture, in accordance with some embodiments. The central unit (CU) is divided up into the CU-CP (control plane) and CU-UP (user plane), and provides support for the higher layers of the protocol stack such as SDAP, PDCP and RRC. Sometimes multiple CU-UPs are needed to provide support for a large number of users. The CU-CP and CU-UP are in communication with a plurality of distributed units (DUs). A SMO (service management and orchestration) is present in the core network as well. Mobility is provided by the AMF/SMF (access management function/session management function). The 5G User Plane Function (UPF) is the function that does all of the work to connect the actual data coming over the Radio Area Network (RAN) to the Internet. OpenRAN architecture splits the CU-UP, the CU-CP, and the DU from each other. Not shown are near real-time RIC (RAN intelligent controller) and non-real-time RIC.

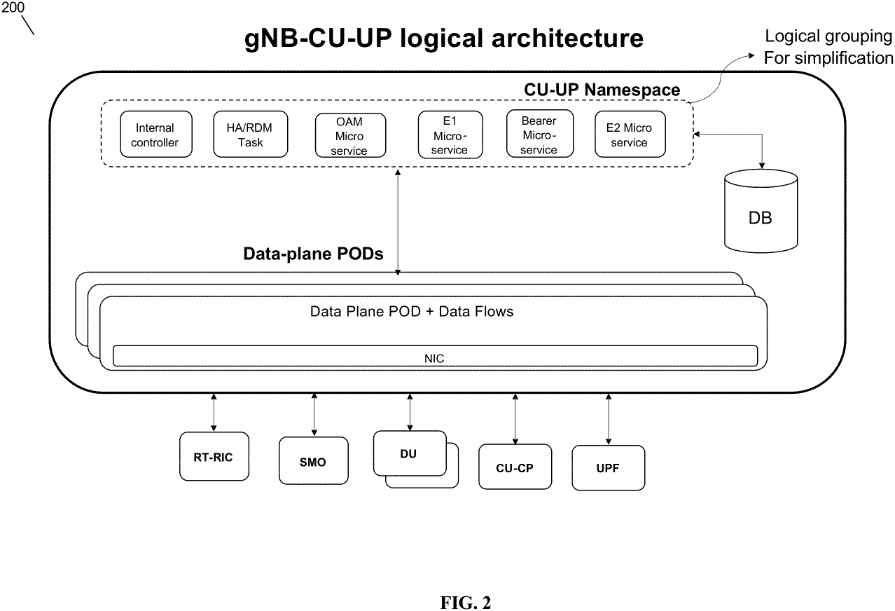

FIG. 2 depicts a schematic logical architecture of a gNB-CU-UP, in accordance with some embodiments. At 200, there are multiple micro-services and pods in single gNB-CU-UP: internal controller, high availability (HA)/RDM task, OAM (operations, administration, and maintenance), E1 microservice for E1 interface communications, bearer microservice for handling bearers, and an E2 microservice for E2 interface communications. These microservices operate in concert and are grouped in the diagram for simplification. These microservices are in communication with a plurality of data plane pods, each with data flows and network interface cards (NICs), virtual or real. For Simple deployment model of gNB-CU-UP can have one or multiple data-plane PODs with multiple cores on each POD to provide required gNB-CU-UPdata throughput.

Now suppose if any of the data-plane POD crashes then there will be service disruption for subscribers being served by that specific POD for a duration till new data-plane POD comes up and end subscriber re-establishes data sessions. This service disruption impact can be huge in terms of % subscriber base served by gNB-CU-UP.

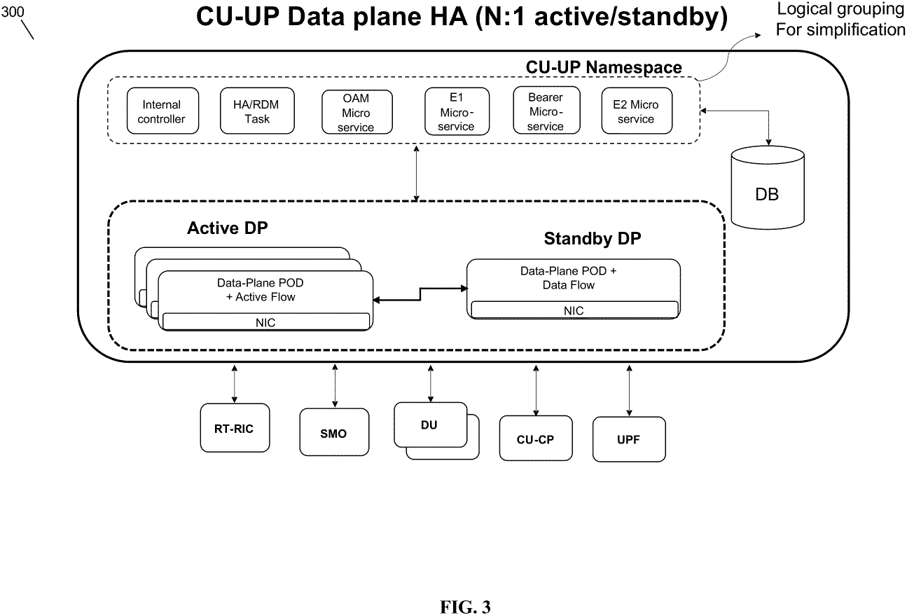

FIG. 3 depicts a schematic logical architecture of a gNB-CU-UP data plane with high availability, in accordance with some embodiments. gNB-CU-UP data-plane PODs can be made highly available to serve end subscribers. Whole transition can happen very quickly in order of milli-seconds to few seconds.

Let’s say there are ‘N’ data-plane PODs to handle subscriber uplink and downlink user-plane traffic. Control plane module in gNB-CU-UP will install uplink & downlink flows in data-plane pod to handle subscriber traffic from DUs & UPF. For ‘N’ Data-plane PODs, a single POD will be provisioned as passive/standby POD in gNB-CU-UP by SMO, here labeled Standby DP. All active data-plane POD will send flow information for backup to standby/passive data-plane POD.

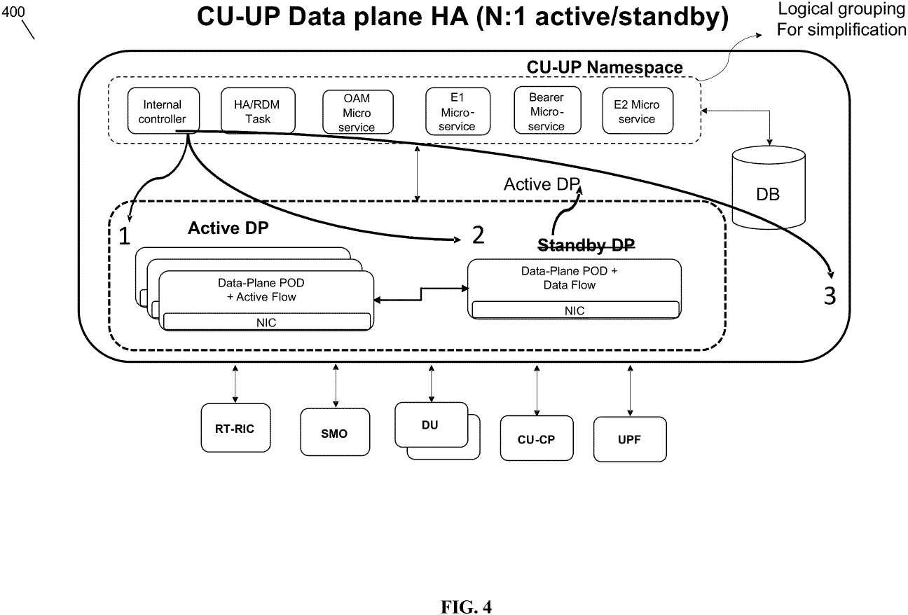

Now let’s say one of the Data-plane POD/task has crashed. This is shown in FIG. 4.

FIG. 4 depicts a schematic logical architecture of a gNB-CU-UP data plane with high availability in operation, in accordance with some embodiments. At step 1, crash detection is performed by internal controller. At step 2, standby DP state label is changed to become active. At step 3, move IP from active instance IP to this instance.

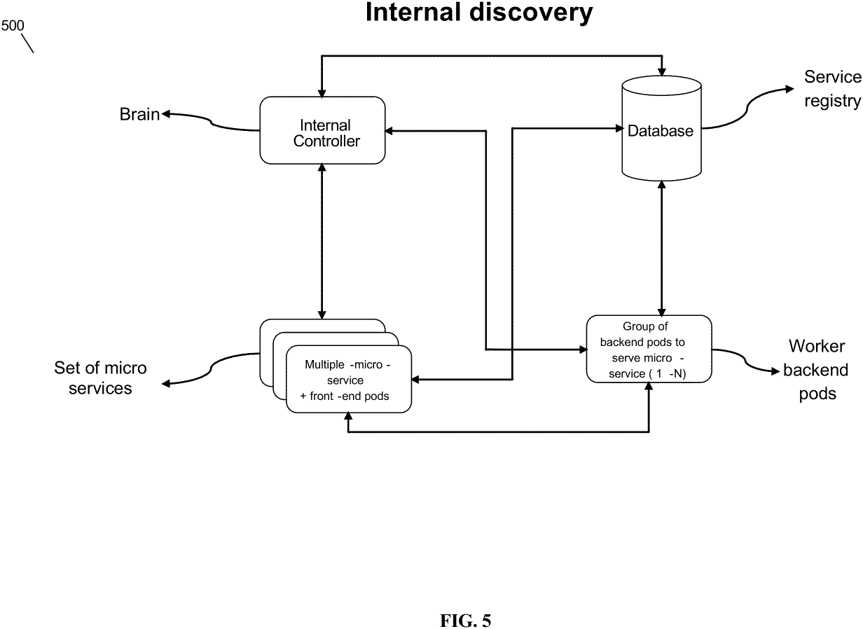

FIG. 5 shows a schematic architecture for an internal service discovery framework, in accordance with some embodiments. Internal controller will keep track of internal changes in given namespace/cluster.

Internal controller: It keeps track of health of all PODs & micro services in a given namespace. As soon as any pod/container crashes, it updates the remaining pods. And takes necessary steps to bring system in workable state.

Database (Service registry): This database act as service registry database for all pods and micro-service in given namespace. All the pods on start-up can update required information in database & fetch required information from service registry database.

Data-plane POD crash and high availability. If any of the Data-Plane pod crashes, internal controller would identify based on liveliness probes or heart-beat missing events. Internal controller would initiate procedure to make passive/standby POD to active state. Internal controller would inform credential of the Data-plane pod to passive POD.

Passive/standby POD already maintain all the flows of all active PODs in it as backup. Passive POD would identify the flows of the impacted data-plane POD and mark those flows to active state. Mark remaining non-active flows passive/standby POD to be removed.

Internal controller will trigger label change of this passive/standby data-plane POD; Migrate Data-plane IP of crashed POD to this passive /standby data-plane POD; and SMO will launch new standby/passive POD for backup. Label change may be done using POD configuration mechanisms such as Kubernetes, in some embodiments.

Internal controller is aware of all services running on the failed data plane POD and keeps the standby up to date with the same set of services and with configurations of those services, in some embodiments, which may utilize the service registry to track this functionality, in some embodiments. When the failover occurs, depending on whether orderly shutdown occurs on the failed POD, up to date state may or may not be able to be synced. Failover may involve identifying and marking flows of certain impacted data flows, in some embodiments. In some embodiments, flows that are not active may be marked for removal.

A single standby DP can be used, in some embodiments, or an active-active standby, or a set of multiple standbys, in some embodiments.

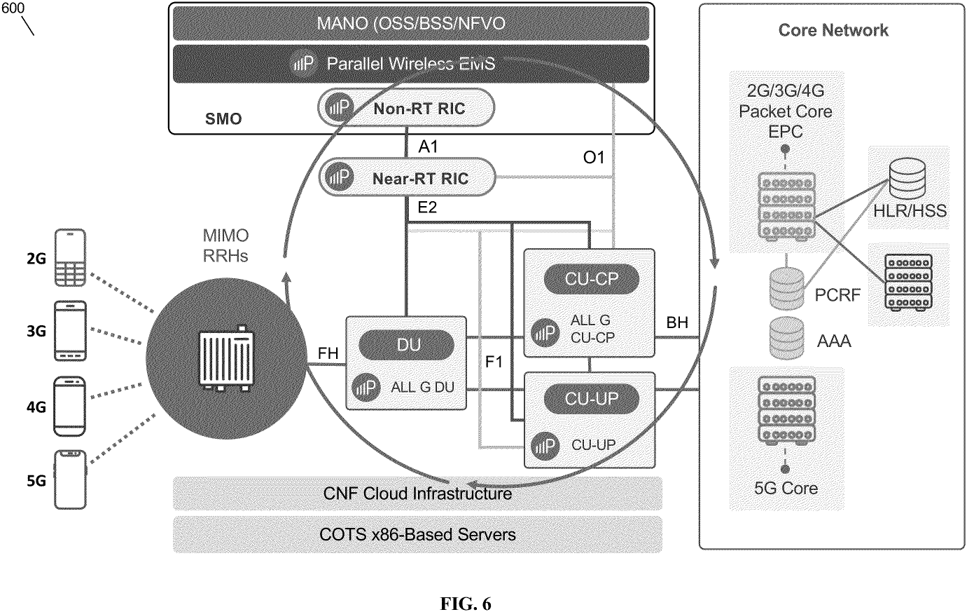

FIG. 6 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users.

As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, to 2G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of providing gNB-CU-UP data plane high availability in public/private cloud, the method comprising:
identifying, by an internal controller, when a data-plane Pod crashes;
initiating, by the internal controller, procedures to make a passive POD to an active state; the procedures including at least one of :
maintaining, by the passive POD, all flows of all active PODs in it as backup;
identifying, by the passive POD, flows of the impacted data-plane POD and marking those flows to an active state;
marking remaining non-active flows at the passive POD to be removed;
triggering, by the internal controller, label changing of the passive data-plane POD;
migrating data-plane Internet Protocol (IP) of crashed POD to the passive data-plane POD; and
launching, by a Service Management and Orchestration (SMO), a new passive POD for backup.
